(19) United States
(12) Patent Application Publication
(10) Pub. No.: US 2002/0180570 A1
(43) Pub. Date: Dec. 5, 2002

(54) Method and apparatus for dielectric spectroscopy or biological solustions

(75) Inventors: Geoffrey R. Facer, San Francisco, CA (US); Lydia L. Sohn, Princeton, NJ (US); Daniel A. Notterman, Princeton, NJ (US)

Correspondence Address: BEYER WEAVER & THOMAS LLP, P.O. BOX 778, BERKELEY, CA, 94704-0778, US

(73) Assignee: The Trustees of Princeton University, Princeton, NJ

(21) Appl. No.: 10/047,453

(22) Filed: Oct. 26, 2001

Related U.S. Application Data
(60) Provisional application No. 60/243,596, filed on Oct. 26, 2000.

(51) Int. Cl. H01P 3/02; H01P 5/00

(52) U.S. Cl. 333/239; 333/248; 333/157

(57) ABSTRACT

A coplanar waveguide for use in dielectric spectroscopy of biological solution is described. The waveguide's inner conductor can have a small gap and a sample containing space is laid over the gap. The sample containing space holds a small volume, ranging from a few picoliters to a few microliters of a biological solution. The waveguide is then driven with electrical signals across an extremely wide frequency range from 40 Hz to 40 GHz. The waveguide is coupled to a network or impedance analyzer by means of appropriate connectors and the response of the biological solution to the input signals is recorded. One-port and two-port measurements can be made without any modifications. The simple geometry of the waveguide makes it easy to integrate with microfluidic systems.

### RELATED APPLICATIONS

This application claims priority under 35 U.S.C. §119(e) to U.S. Ser. No. 60/243,596, filed Oct. 26, 2000, which is incorporated by reference in their entirety for all purposes.

### FIELD OF THE INVENTION

The present invention relates generally to the analysis of biological solutions. More particularly, it relates to dielectric spectroscopy of biological solutions.

### BACKGROUND OF THE INVENTION

The revolution in biological science represented by efforts such as the Human Genome Project, as well as advances in related fields including combinatorial chemistry, has created an enormous demand for the testing and analysis of biological solutions. These solutions can include live cell cultures, suspensions of live cells, solutions containing parts of cells such as ribosomes or nuclei or solutions containing the proteins or nucleic acids that cell cultures generate. For purposes of this entire specification and the appended claims, biological solutions should be interpreted broadly as at least including any of the types of solutions and suspensions just listed. Proteins and other cell products shall be described herein as macromolecules. Rapid characterization of biological solutions containing any or all of the preceding components is increasingly important as the number of such biological solutions being studied is increasing almost exponentially.

As the biological solutions frequently contain living organisms, it is particularly critical that the tests applied to the solutions perturb the solutions as little as possible. Otherwise, the characteristics of the solution that are being measured may be altered in undesirable ways, distorting the test results. Many existing techniques for analyzing biological solutions rely upon the introduction of fluorescent dyes to the solutions. The uptake of the solutions into the organisms being studied and the rate of that uptake can provide useful information about the solution. Unfortunately, the addition of these dyes inevitably alters the solution chemistry to some degree, which is problematic when the precise chemical environment of the macromolecules in the solution is critical. Photo-bleaching, whereby the fluorescent dyes break down from exposure to UV or optical radiation, can place a time limit on optically probing samples tagged with fluorescent dyes. Further, different tests often require different dyes. This requirement leads to a multiplication of the tests that must be conducted on each solution, with consequential increases in costs and elapsed time. See also S. Nie and R. N. Zare, Annu. Rev. Biophys. Biomol. Struct. 26, 567 (1997), S. Weiss, Science 283, 1676 (1999) and G. MacBeath and S. L. Schreiber, Science 289, 1760 (2000). These papers are incorporated herein by reference for all purposes.

As an alternative to the use of dyes to study biological solutions, electric fields imposed upon biological solutions have also been used to characterize the biological solutions. The use of electric fields to study biological solutions does not require any modifications or particular preparations of the biological samples under study. As the solution is not modified by the addition of substances necessary to conduct the tests, the results accurately reflect the components of the solution. Additionally, as the solutions are not altered by the tests, there is no critical time period during which the tests must be conducted and no restrictions on the reuse of the biological solutions. See also J. Viovy, Rev. Mod. Phys. 72, 813 (2000) and L. L. Sohn, O. A. Saleh, G. R. Facer, A. J. Beavis, R. S. Allan, and D. A. Notterman, Proc. Natl. Acad. Sci. U. S. A. 97, 10687 (2000). These papers are incorporated herein by reference for all purposes.

Low frequency electromagnetic fields, on the order of ˜10 Hz to 1 MHz, have been used since approximately 1940 to characterize the electrical properties of biological solutions. Such impedance studies encompass capacitance and resistance measurements.

The use of low frequency fields to study the dielectric properties of biological solutions is also known. In capacitance cytometry, a single fixed frequency field is applied to a biological sample in a capacitance bridge device. In the reported embodiment, the frequency is 1 kHz, but applying different frequencies from approximately 100 Hz to approximately 10 MHz is expected to yield additional information. The output from the capacitance bridge reflects the transient response of either a single cell or of a small group of cells as it or they pass through the test device. Capacitance cytometry is known. New York, 1993), Vol. 5, pp. 177-200, P. Debye, Polar Molecules (Dover, N.Y., 1929), G. De Gasperis, X. Wang, J. Yang, F. F. Becker, and P. R. C. Gascoyne, Meas. Sci. Technol. 9, 518 (1998), A. K. Jonscher, Nature (London) 267, 673 (1977). These papers are incorporated herein by reference for all purposes. Access to a broad frequency range is important with biological samples, due to their chemical diversity. See B. Onaral, H. H. Sun, and H. P. Schwan, IEEE Trans. Biomed. Eng. 31, 827 (1984) and P. A. Cirkel, J. P. M. van der Ploeg, and G. J. M. Koper, Physica A 235, 269 (1997). These papers are incorporated herein by reference for all purposes.

One known device and method for performing dielectric spectroscopy on a biological solution is shown in J. Hefti et al., “Sensitive detection method of dielectric dispersions in aqueous-based, surface-bound macromolecular structures using microwave spectroscopy,” Applied Physics Letters, Vol. 75, No. 12, 20 September 1999 (Hefti). In Hefti, a two-element stripline configuration is used to study biological solutions. A sample container is placed on top of the center conductor, with a dielectric spacer placed between the conductor and sample container to create the appropriate impedance. Signals in the range of 45 MHz to 21 GHz are driven through the device by a network analyzer to measure the dispersion properties of the biological solution. Although the Hefti device provides useful data on biological solutions, its results chiefly characterize surface binding of the elements in the solution with the transmission line. The volume of sample needed by the Hefti device as well as the environmental support apparatus required by it are both undesirable.

An apparatus and method for dielectric spectroscopy that is compact and readily adaptable for use with extremely small quantities of biological solutions and that can rapidly perform dielectric spectroscopy over a broad frequency range would be a significant advance in this particular field.

In addition to swept-frequency operation, it is possible to operate CPW 10 using a fixed oscillation frequency. One such embodiments includes attachment of one or more fixed-frequency oscillators which can be electrically connected to CPW 10, individually or simultaneously. One or more corresponding detectors, sensitive to fields at the frequencies of the active oscillators, can be employed to sense the response of the sample. In an alternate embodiment, the swept-frequency analyzers described above can be controlled to dwell upon a particular frequency, both applying the field and sensing the response from the sample.

This new device and method avoids sample preparation problems created by the addition of a dye to the biological solution, obviates the need for a different dye for each separate test and is not susceptible to the limitations on testing time occasioned by photo-bleaching of the added optically active dyes. Unlike previously known devices for dielectric spectroscopy, the CPW taught herein can readily be adapted to function with microfluidic or nanofluidic sample delivery systems, requires no environmental support apparatus and can readily be combined with other analytic systems to characterize the biological solutions under study even more completely. See J. M. Cooper, Trends Biotechnol. 17, 226 (1999) and D. C. Duffy, J. C. McDonald, O. J. A. Schueller, and G. M. Whitesides, Anal. Chem. 70, 4974 (1998). These papers are incorporated herein by reference for all purposes. Previously known devices used for dielectric spectroscopy relied on resonant cavities to hold the biological solutions, which strongly limited the range of frequencies that can be used, or, alternatively, used line terminations at the sample, which reduced the measurable range of the complex impedance of the biological sample.

The present invention, in its preferred embodiments will now be discussed in detail, with reference to the figures listed below.

### BRIEF DESCRIPTION OF THE DRAWINGS

The invention, together with further advantages thereof, may best be understood by reference to the following description taken in conjunction with the accompanying drawings in which:

FIG. 1 illustrates a first embodiment of the present invention;

FIG. 2 illustrates a first biological sample holder for use with the present invention;

FIGS. 3a and 3b illustrate a second biological sample holder for use with the present invention;

FIG. 4 is a block diagram showing the functional components of the first testing environment using the present invention;

FIG. 5 is a block diagram showing the functional components of a second testing environment using the present invention;

FIG. 6 shows the response of oxygenated hemoglobin at microwave frequencies;

FIG. 7a shows relative permittivity data for real components and FIG. 7b shows relative permittivity data for imaginary components. Solid traces are from hemoglobin (100 μg/mL), dashed traces for Tris buffer ( 1 mM, pH 8), and dotted curves are Cole-Cole calculations as per Equation 1 (parameters ε_{LF}-ε_{HF}=1340, τ=1.70 μs, α=0.91, and α_{LF}=40 nS); and

FIG. 8 shows microwave transmission data. FIG. 8a shows raw data, for the cases of no sample (dotted line) and a 100 μg/mL hemoglobin solution (solid). FIG. 8b shows normalized data (using the respective buffers) for 100 μg/mL hemoglobin (solid trace) and 300 μg/mL phage λ-DNA (dashed), showing the difference in their microwave responses. In FIG. 8c, the solid trace is the (buffer-normalized) response of E. coli and the dotted trace is that of the Tris buffer from the hemoglobin solution (normalized using deionized water).

### DETAILED DESCRIPTION OF THE INVENTION

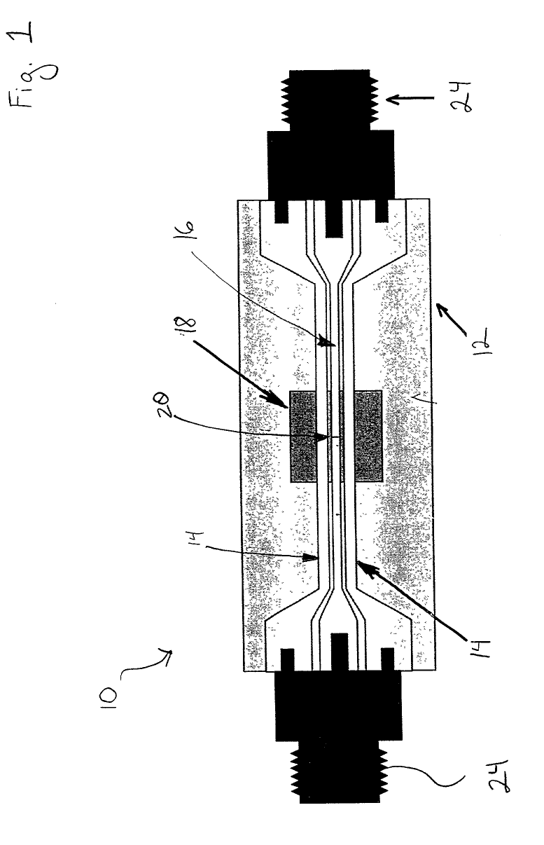

As shown in FIG. 1, CPW 10 comprises at least a pair of outer conductors 14 and an inner conductor 16 fabricated on glass substrate 12. Although glass is used as the substrate in this first embodiment, in other embodiments silicon or another inert material of similar physical qualities can be used.

In the central portion of CPW 10, which central portion herein means at least that portion of conductors 14 and 16 which are overlain by a biological sample container 18, the inner and outer conductors run parallel to one another. In this first preferred embodiment, inner conductor 16's width is approximately 40 micrometers wide and the outer conductor 14's width is approximately 380 micrometers wide. The spacing between the inner conductor 16 and the outer conductors 14 depends on the width of the inner conductor. The width of the outer conductor preferably is at least equal to width of the inner conductor. In this and other embodiments of the present invention, outer conductors 14 should preferably be at least five times as wide as inner conductor 16.

The width of inner conductor 16 depends upon the nature of the biological solution being analyzed. The width of inner conductor 16 should be adjusted to roughly match the size of the cells, organelles or macromolecules that will be studied using CPW 10. The length of gap 20 in inner conductor 16 should also be adjusted to optimize the transmitted signal level while remaining as close as possible to the size of the entities under examination. For example, if CPW 10 is used to study cells, and the cells have a rough average size of between 1 and 10 microns, then the width of inner conductor 14 and the length 21 of gap 20 should be on the scale of 1 to 10 microns. Spacing 22 between inner conductor 16 and outer conductors 14 is chosen to achieve matching of the characteristic impedance of the CPW to external cables and adaptors. In the present embodiment, the spacing 22 is 7 microns. In other embodiments, spacing 22 is in the range of 4 to 20 microns.

Gap 20 is typically made at or near the midpoint of inner conductor 16. However, it will be appreciated that gap 20 can be located elsewhere along the length of inner conductor 16 so long as it is accessible to the sample.

Although not illustrated, another embodiment of the present invention eliminates gap 20 in inner conductor 16. The elimination of gap 20 presents no technical difficulties with respect to the fabrication of CPW 10. Although an embodiment without a gap in the inner conductor might not perform as well as the described preferred embodiment, the reduced cost of manufacture, as well as the flexibility in where to locate the container holding the biological solution under test might justify the difference in performance. In addition, the total transmitted power in such an embodiment is higher than in an embodiment with a central gap 20, which can be advantageous.

In yet another embodiment of the present invention, gap 20 in inner conductor 16 is matched with corresponding gaps in outer conductors 14. The gaps in the outer conductors 14 are not necessarily the same width as the gap 20 in the inner conductor 14. Such a gap, extending across the outer and inner conductors, is easy to fabricate and may perform better than the first preferred embodiment in certain electromagnetic wave frequency ranges.

The ranges of sizes proposed for the widths of the inner conductor and outer conductors, the spacing between the inner conductor and the outer conductors and the length of the gap in the inner conductor all depend on several considerations that involve engineering tradeoffs determined by these factors. The exact size of the cell, organelle or macromolecule under study is one factor. The frequency range that will be used to study the biological solutions is another factor. Another factor can include proper impedance matching between the connectors used to couple CPW 10 to external signal generators and test devices. Given these factors, a range of sizes for the widths of the inner and outer conductors, the gap between them and the gap in the inner conductor will all generate acceptable performance. Adequate performance can be expected where inner conductor 16 is between 1 and 100 microns wide, outer conductors 14 are more than 10 microns wide, outer conductors 14 are separated from inner conductor 16 by a gap of between 1 and 50 microns and gap 20 in inner conductor 16 has a length of between 0.5 and 50 microns.

CPW 10 is fabricated using known lithographic techniques, including electron beam evaporative metal deposition and photolithography. Masks and photoresists are used in a known manner to lay out inner conductor 16 and outer conductors 14, as well as gap 20. Both inner conductor 16 and outer conductors 14 are comprised of gold or other conductor capable of efficiently transmitting high frequency signals, with a seed layer of biological sample under consideration, native oxides on the electrode material, various ceramic constituents, and insulating materials whose surface properties are, or can be adjusted to be, beneficial for the practical operation of the CPW devices. In the formation of the thin insulating layer, care must be taken to minimize the formation of pinholes or other defects through the layer, as these may allow electrochemical effects and nonlinear measurement artifacts at frequencies up to the GHz range, in some devices.

In the present embodiment, signals are injected into and received from CPW 10 by means of SMA end-launch printed circuit board connectors 24. The connectors are soldered to broad pads at the ends of inner conductor 16 and outer conductors 14. The transition between the broad pad areas and the smaller CPW scale in the measurement region is achieved by tapered geometries chosen to minimize reflections and unintentional alterations in characteristic impedance. Several other methods can be used to couple CPW 10 to the appropriate signal generation and measurement instruments. Electrical probes such as those used to test semiconductor integrated circuits during their manufacture can be used to contact the ends of conductors 14 and 16 directly, without the need for a connector. An example of such a probe is the “Air Coplanar Probe” series available from Cascade Microtech, Inc., Beaverton, Oreg. In general, the thicker conductors 14 and 16 are, the lower the dissipative losses in the CPW metal will be, and the more robust will be the connections from external leads to the CPW.

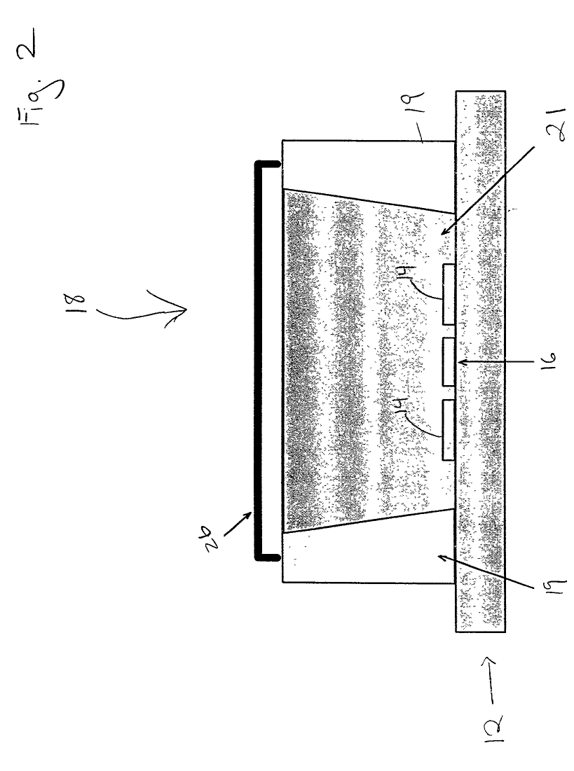

As shown in FIGS. 1 and 2, in a first embodiment of the present invention a static well 18 is used to contain the biological solution. Well 18 is fashioned from a shaped silicone or polymer, herein poly-dimethyl siloxane (PDMS) and rests directly upon conductors 14 and 16, located on gap 20. The first embodiment's sample containment well 18 holds roughly 10 microlitres of solution. Well 18 may be either sealed or unsealed, as the laboratory environment demands. As shown in FIG. 2, cap 26 covers well 18, which has sidewalls 19 to hold biological solution 21. Given the small size of the well and the relatively short duration of the tests, evaporation even when the well is unsealed is not a significant concern in many situations.

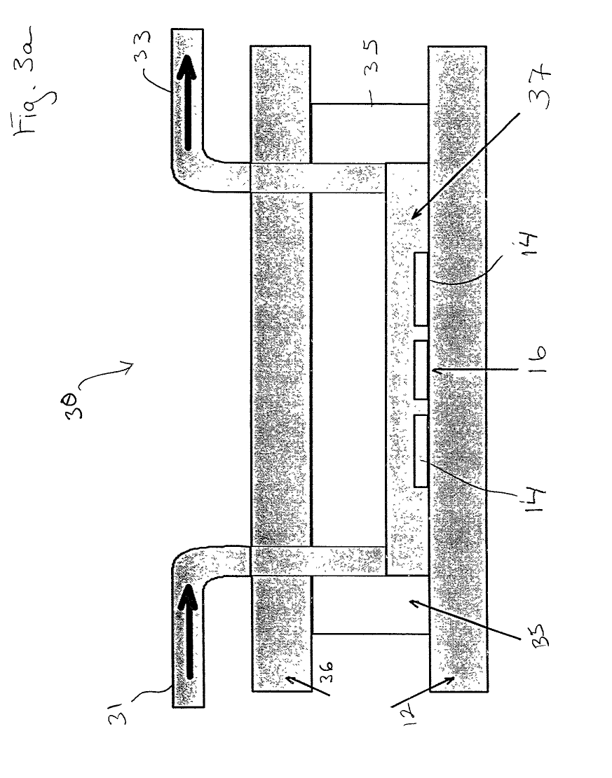

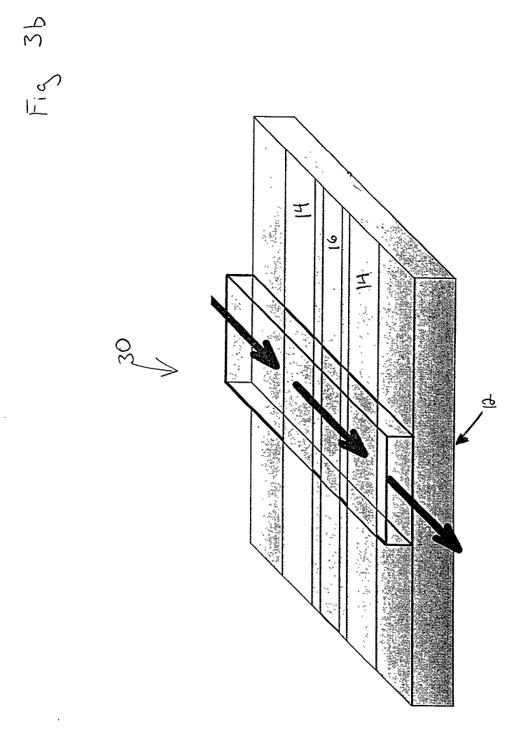

As shown in FIGS. 3a and 3b, biological solutions can also flow across CPW 10 through microfluidic (or nanofluidic) channel 30. In this specification, microfluidic shall be taken to mean any channel or system wherein the total volume of biological solution at any one time is not more than 10 microlitres or wherein the cross-sectional dimensions of

In certain embodiments of the present invention, the size of sample well 18 and container 37 are further reduced, as the technology is not fundamentally limited by size until the scale of few nanometers is reached. Similarly, CPW 10 can also be scaled down to enable more detailed measurements of the properties of cells, cell components, and macromolecules. The scaling down may be accomplished by ultraviolet photolithography or by electron beam lithography. As appropriate, the scale can be reduced to allow testing of a single cell or organelle. Implementing the technique at the single cell scale allows more detailed measurements of the properties of cells and large macromolecules, and allows the determination of statistics of the types, developmental stages and other characteristics of the cells present.

The present invention is useful for analyzing biological solutions and suspensions. Both the constituents and the immediate chemical environment of such solutions and suspensions can be analyzed. In one embodiment, the present invention generates electrical spectral data, rapidly enough so that the progress of intra-cellular processes can be monitored.

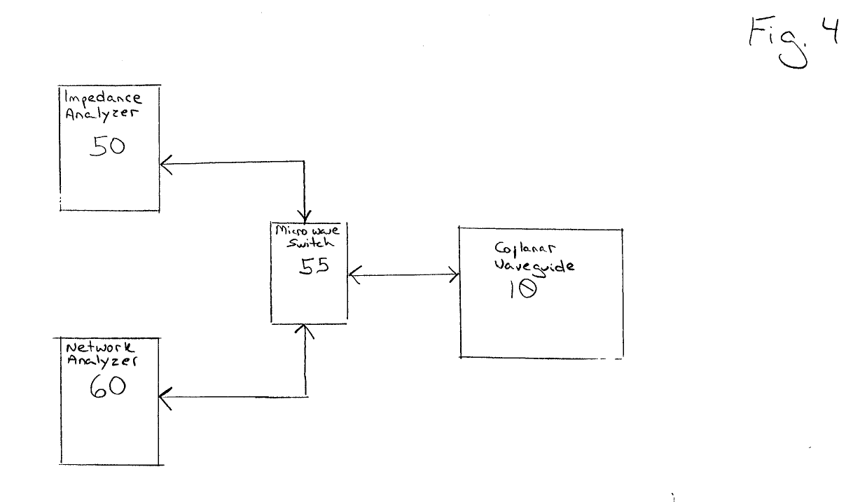

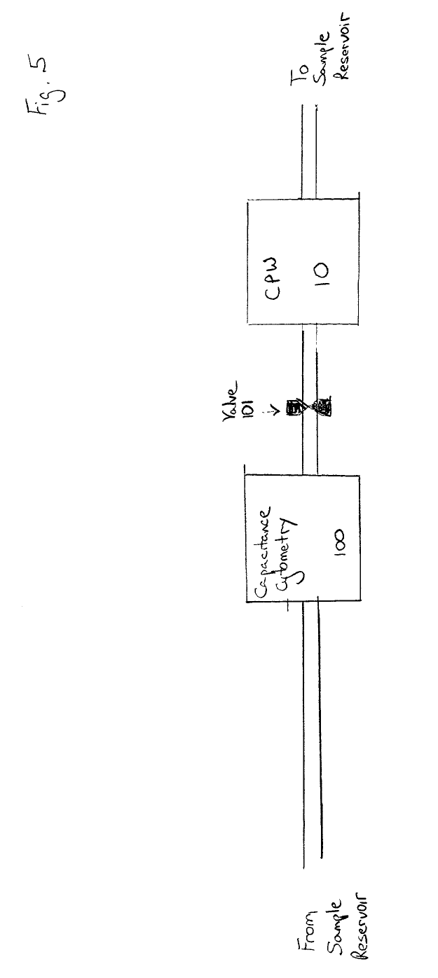

FIG. 4 is a block diagram showing how the present invention operates, in accordance with a specific embodiment. In this embodiment, CPW 10 is coupled to impedance analyzer 50 and network analyzer 60 by means of microwave switch 55. Impedance analyzer 50 generates a test signal of between roughly 10 Hz and 100 MHz and simultaneously detects the response of the biological solution in that frequency range. Above approximately 100 MHz, switch 55 takes impedance analyzer 50 off-line and couples network analyzer 60 to CPW 10. Network analyzer 60 generates test signals from approximately 50 MHz up to at least 40 GHz and simultaneously detects the response of the biological sample to these frequency ranges. For operation in a more limited range of frequencies, accessible by any one measurement analyzer, a microwave switch is not required. Similarly, manual reconfiguration by connecting and disconnecting one analyzer instrument at a time can also remove the need for a microwave switch.

At frequencies below ˜100 MHz, the relative permittivity eᵣ of the sample is obtained from the impedance Z via the formula Z=1/(j 2.pi.f.Coeᵣ), where Co is the capacitance through the sample volume when empty, which is typically ˜10 fF, and f is the frequency of the applied field. Z data may be obtained with a Hewlett-Packard 4294A impedance analyzer with an excitation amplitude of 500 mV. The data can be made free

The current invention has already been used to discriminate between different solution buffers, detecting their particular ion concentrations, between cell suspensions in buffer and control solution of matching buffers, between different cell species, as well as to detect the relaxation frequencies of various solvents, which range from ˜100 Hz to beyond 100 Mhz, in different solutions.

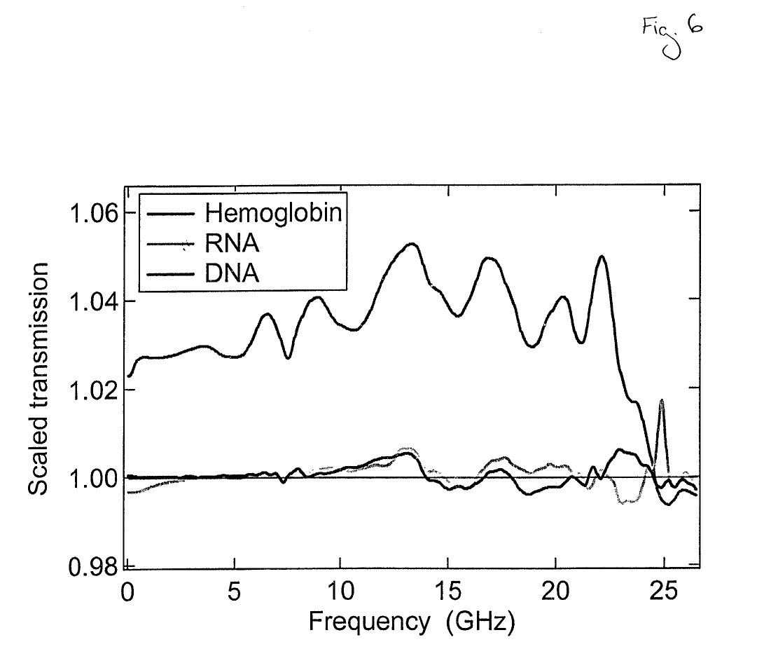

As one example of the output from the CPW when used in the testing environment shown in FIG. 4, FIG. 6 shows how oxygenated and de-oxygenated hemoglobin respond to frequencies between 1 and 27 GHz. Although the differences in response are not large, they are clearly sufficient to enable the present device to easily discriminate between the two states. Such a differential response by the same molecule to different environmental stimuli is only one example of the type of information that the present invention can generate.

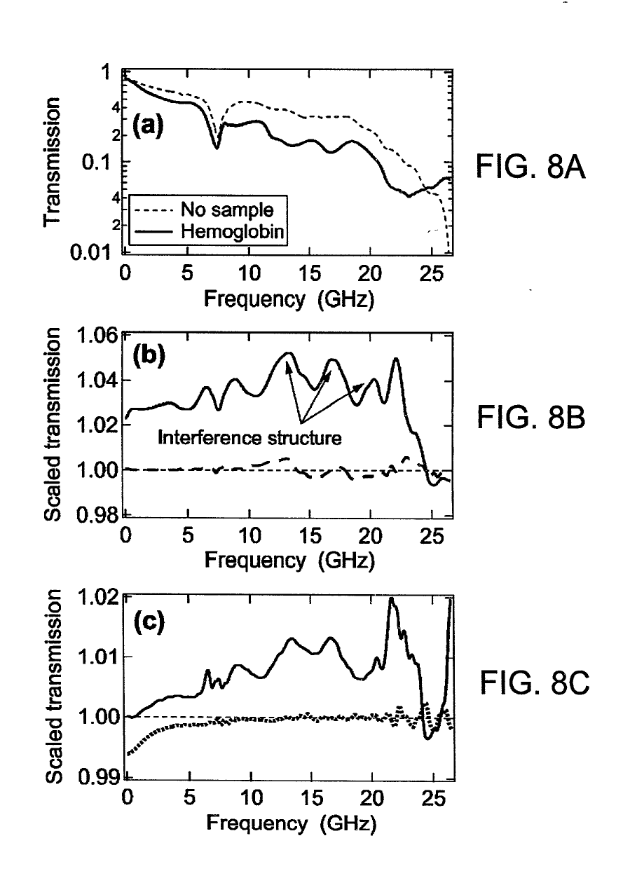

A variety of samples, including solutions of hemoglobin (derived from washed and lysed human red blood cells) and bacteriophage λ-DNA, and live E. coli suspensions have been examined using the apparatus described herein. Example microwave data are shown in FIGS. 8a, 8b and 8c. For these figures, the concentration of hemoglobin is 100 μg/mL in 0.25 M Tris buffer (pH 8), and that of DNA is 500 μg/mL in 10 mM Tris and 1 mM EDTA (pH 8) buffer (available from New England Biolabs, Beverly, Mass.). E. coli are suspended in 85% 0.1 M CaCl₂/15% glycol. For the measurements, both molded microfluidic channels and simpler enclosed wells were employed. Results were consistent (within a scaling factor for the fluid—PW overlap length) for sample volumes ranging from ≦3 pL to ≧20 μL.

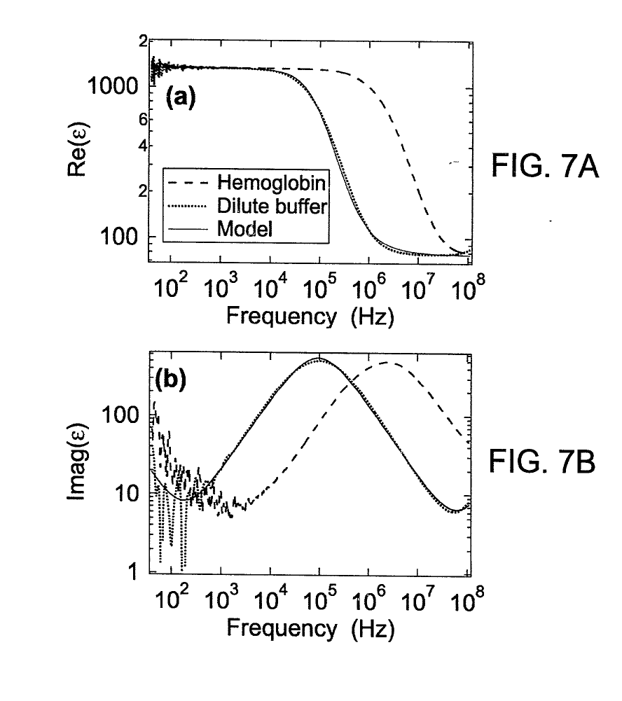

Use of capped 10 μL wells gave the following results. FIG. 7 shows ε from 40 Hz to 100 MHz, for hemoglobin, dilute Tris buffer (concentration 1 mM, pH 8) and a Cole-Cole model calculation relating ε to the angular frequency ω (see, Cole and Cole (1941) J. Phys. Chem. 9:341, which is incorporated herein by reference in its entirety):

$$ϵ = {ϵ}_{HF} + \frac{{ϵ}_{LF} - {ϵ}_{HF}}{1 + {( j ω τ )}^{α}} - j {σ}_{LF} / ω \qquad ( Equation 1 )$$

Here ε_{LF}-ε_{HF} is the “dielectric increment”, τ is a characteristic time constant, α≦1 defines the sharpness of the transition, and α_{LF} is the DC conductivity. For the calculation in FIG. 7, ε_{LF}-ε_{HF}=1340, τ=1.70 μs, α=0.91, and α_{LF}=40 nS. A small series resistance (90 Ω) is included in the model to fit high-frequency loss within the CPW.

The spectra in FIG. 7 show two features. First, the dielectric increment of the high-frequency transition is a constant of the measurement geometry. Second, and in contrast, the ε_{LF}→ε_{HF} transition frequency is directly proportional to the total ionic strength of the solution. As shown, the dispersion model (Equation (1)) describes the data very well.

FIG. 8 shows transmission data from 45 MHz to 26.5GHz. In FIG. 8(a), raw transmission and reflection are shown for two control cases: a dry sample setup, and deionized water. FIG. 8(b) and (c) contain transmission data sets for hemoglobin, DNA, and live E. coli which have been normalized with respect to their corresponding buffers. FIG. 8(c) also shows (dotted trace) transmission data from the buffer used for hemoglobin measurements, normalized using deionized water data. This in particular demonstrates that even at high salt concentrations (0.25 M Tris-HCl) the microwave effects of buffer salts are limited to a monotomic decrease in transmission below 10 GHz.

Three descriptive notes can be made regarding the data: first, periodic peak and trough features (such as those marked by arrows in FIG. 8) are interference effects due to reflections at the SMA adapters and the fluid itself. Second, the SMA adapters impose the high frequency cutoff at 26.5 GHz, which has been circumvented in later embodiments of the device by the use of adaptors more suited to high-frequency operation. Third, reproducibility of the microwave data has been verified for more than three CPW devices, using several successive fluidic assemblies on each. Only the interference structure changes slightly from device to device.

The most striking aspect of the microwave data is that the transmission through the hemoglobin and bacteria specimens is higher than that through their respective buffer samples. In addition, the response due to 100 μg/mL of hemoglobin is far stronger than that for DNA, even though the DNA is more concentrated (500 μg/mL). Furthermore, the able to cover both the high frequency range above 1 GHz and the low frequency range below 1 kHz with one system. Additionally, the present invention can be readily adapted for use in a microfluidic or nanofluidic test environment, a considerable advantage when analyzing costly biological molecules.

Although the CPW devices yield a great deal of information across a frequency range from ˜10 Hz to ˜50 GHz, certain frequency ranges are preferable for particular applications and embodiments.

For examining certain macromolecular solutions, such as those containing nucleic acids and proteins, low frequencies can be desirable due to the high permittivities associated with these species under such measurement conditions, and the saturation of the permittivity contribution from small ions, as evidenced by the plateau at low frequency in FIG. 7a. For example, a frequency less than 1 MHz can be employed, and more preferably below 10 kHz. Especially in embodiments where the CPW is coated by an insulating layer, frequencies of under 1 kHz can be preferable.

For alleviating the effects of ionic screening, frequencies greater than 100 MHz are preferred for solutions with moderate to high ionic concentrations. In particular, frequencies above 1 GHz, and more preferably above 5 GHz are well suited to avoiding the complications arising from screening by small ions.

In embodiments where SMA adaptors are employed, a maximum operational frequency of 26.5 GHz is preferred.

Particular frequencies are of prime interest for any sample, depending on the constituents of the sample and the information desired. The selection of those frequencies, for either employment of fixed-frequency oscillators or more detailed frequency sweeps, is made more efficient and effective by reference to a “library” of spectral data obtained from comprehensive frequency sweep data on similar samples. The particular information desired (for example, quantitative as opposed to simple detection) will also play a role in selecting frequency parameters.

The coplanar waveguide sensor can be used to obtain data on time-dependent phenomena. This can be achieved by either performing multiple sweeps in sequence, or operation at a fixed frequency as described earlier. One application of this embodiment is monitoring the properties of the contents of the channel over a given time period. Examples in which this is applicable include monitoring of cell culture development where a particular cell or collection of cells remain at the measurement location, and continuous sampling from a larger volume of fluid, with cells or other objects being probed sequentially. This monitoring can be used to measure the effect of changing conditions, such as temperature changes or chemical exposure, on the sample. A further example is the detection of transient phenomena associated with an object, or gradient of concentration, flowing past the CPW.

Detection of transients, or of slower changes beyond a predetermined threshold, can be used to trigger further measurements or operations elsewhere in the device, or to initiate notification of users via an external readout or alarm. Examples of triggered operations include, but are not limited to, sorting processes.

The CPW devices can be integrated with optical devices for further analytical applications. One major limitation of optical sensing is photobleaching, which is the loss of fluorescence capability by dyes due to overexposure to optical or ultraviolet radiation. These difficulties can be overcome by creating hybrid CPW/optical devices, where optical excitation time is minimized in conjunction by utilizing CPW-based triggering. Such an embodiment allows optical investigations to be extended over longer time periods than can presently be easily achieved.

Objects which can be detected via transient signals as described above include cells, including red or white blood cells, cultured celis, cells from biopsy tissue, liposomes, including artificial lipid-membrane-bound vesicles containing solutions or other fluids and artificial beads made from metals or insulators, to which a range of substances can be bound. If bubbles or other voids are present in the fluid stream, they can be readily detected.

The total ionic strength in a sample has a simple relation to the cutoff frequency of alpha dispersion, as shown in FIG. 7 and described earlier. Applications of this invention include the use of swept-frequency measurements to determine ionic strength in microfluidic systems. Particular examples of such applications are water quality monitoring at the small scales available to microfluidic systems, and testing of

We claim:

1. A coplanar waveguide for dielectric spectroscopy, the coplanar waveguide comprising:
a substrate;
an inner conductor deposited on the substrate, the inner conductor having a first predetermined width, and having a gap of first predeterminned length at the midpoint of the conductor;
a pair of outer conductors deposited on the substrate, each of the outer conductors being deposited on one side of the inner conductor, the spacing between the inner conductor and each outer conductor defining a second predetermined width; and
a sample container overlying the gap in the inner conductor and the outer conductors.

2. The coplanar waveguide of claim 1 wherein the first and second predetermined widths are chosen to optimize the coupling between the sample container and external electronic equipment generating and measuring electromagnetic waves for dielectric spectroscopy.

3. The coplanar waveguide of claim 1 wherein a pair of coaxial adaptors are attached, each coaxial adaptor being coupled to the inner conductor and the outer conductors at a respective one of their two ends.

4. The coplanar waveguide of claim 1 wherein the length of the gap in the inner conductor is no more than twice the spacing between the inner conductor and each outer conductor.

5. The coplanar waveguide of claim 1 wherein the length of the gap in the inner conductor is within the range of 0.5 to 50 micrometers, and more preferably in the range of 1 to 10 micrometers.

6. The coplanar waveguide of claim 1 wherein the sample container contains a biological solution and the waveguide is capacitatively coupled to the sample container.

7. The coplanar waveguide of claim 1 wherein the sample container consists of a microfluidic channel with an input and output.

8. A method for performing dielectric spectroscopy on a biological sample, the method comprising the steps of:
creating a gap of first predetermined length in an inner conductor of a coplanar waveguide;
placing a sample container containing a biological solution on the coplanar waveguide, the sample container being located over the gap in the inner conductor;
driving the coplanar waveguide with oscillating signals in a first predefined range of frequencies; and
recording the response of the biological solution to the oscillating signals.

9. The method of claim 8 wherein the sample container is a microfluidic channel with an input and output.

10. The method of claim 9 wherein the sample is flowing in the channel.

11. The method of claim 8 wherein the sample flow in the channel can be temporarily or permanently halted for the duration of a frequency sweep.

12. The method of claim 8 wherein the range of radio frequency signals extends from 40 Hz to 40 GHz.

13. The method of claim 8 wherein the biological solution in the sample container is capacitatively coupled to the gap.

14. A system for performing dielectric spectroscopy comprising:
a coplanar waveguide with a sample holder, the coplanar waveguide having an input and an output, the sample container holding a first biological sample;
a signal generator for generating test signals in a first predetermined range, the signal generator being coupled to the coplanar waveguide's input; and
a signal analyzer for analyzing the response of the first biological sample to the signals generated by the signal generator, the signal analyzer being coupled to the output of the coplanar waveguide.

15. The system of claim 14 wherein the coplanar waveguide comprises an inner conductor and a pair of outer conductors flanking the inner conductor, the sample holder being located over the inner conductor.

16. The system of claim 15 wherein the inner conductor has a gap of first predetermined length, the gap being located underneath the sample container, capacitatively coupling the signals generated by the signal generator into and out of the biological sample contained in the sample container.

17. The system of claim 16 wherein the first predetermined length is the same order of magnitude as the biological objects contained in the biological sample.

18. The system of claim 16 wherein the coplanar waveguide is coupled to the signal generator and signal analyzer by means of SMA connectors.

19. The system of claim 16 wherein the coplanar waveguide is coupled to the signal generator and signal analyzer by means of needle probes.

20. The system of claim 16 wherein the sample container comprises a sealable sample well.

21. The system of claim 16 wherein the sample container comprises a fluidic channel with an input and output.

22. The system of claim 16 wherein the signal generator and signal analyzer comprises both an impedance analyzer coupled to the input of the coplanar waveguide and a network analyzer coupled to the input and output of the coplanar waveguide.

23. The system of claim 22 wherein a microwave switch couples both the impedance analyzer and the network analyzer to the coplanar waveguide.

24. A coplanar waveguide for dielectric spectroscopy, the coplanar waveguide comprising:
a substrate;
an inner conductor deposited on the substrate;
a pair of outer conductors deposited on the substrate, each of the outer conductors being deposited on one side of the inner conductor; and
a sample container overlying the inner conductor and the outer conductors.

25. The coplanar waveguide of claim 24 wherein an ion impermeable insulator layer encapsulating at least a portion of the coplanar waveguide is formed on the inner and outer conductors, the sample container overlying the ion impermeable insulator layer.

26. The coplanar waveguide of claim 24 wherein a pair of coaxial adaptors are coupled to the inner conductor and the outer conductors, one coaxial connector being coupled to one end of each of the conductors.

27. The coplanar waveguide of claim 24 wherein the sample container contains a biological solution and the waveguide is capacitatively coupled to the sample container.

28. The coplanar waveguide of claim 24 wherein the sample container consists of a microfluidic channel with an input and output.

29. A device for characterizing a liquid analyte containing a putative biological component, the device comprising:
a connector for connecting to a source of oscillatory electrical signals spanning a frequency range extending into at least the GHz range;
a coplanar waveguide comprising:
at least two outer conductors straddling
an inner conductor coupled to the connector in a manner allowing the inner conductor to carry the oscillatory signals extending into at least the GHz range, wherein the inner conductor has a gap, and
an ion impermeable insulator layer encapsulating at least a portion of the coplanar waveguide, including the gap in the inner conductor; and
an analyte chamber located over at least a portion of the coplanar waveguide including the gap in the inner conductor, such that the liquid analyte can contact the insulator layer but not the inner conductor or outer conductors.

30. The device of claim 29, further comprising the source of oscillatory electrical signals.

31. The device of claim 30, wherein the source of oscillatory electrical signals comprises a network analyzer.

32. The device of claim 30, wherein the source of oscillatory electrical signals comprises a network analyzer and an impedance analyzer.

33. The device of claim 30, wherein the source of oscillatory electrical signals comprises a plurality of oscillators for providing discrete oscillatory signals to the inner conductor, at least one of said oscillators providing an oscillatory electrical signal in the GHz range.

34. The device of claim 33, wherein the discrete oscillatory signals are at frequencies where the putative biological component provides characteristic electrical responses allowing discrimination of the biological component in the liquid analyte.

35. The device of claim 29, wherein the inner conductor has a width of between about 1 and 100 micrometers.

36. The device of claim 29, wherein the gap in the inner conductor has a length, in the direction of signal transmission, of between about 0.5 to 50 micrometers.

37. The device of claim 29, wherein the insulator layer comprises at least one of silicon nitride and silicon oxide.

38. The device of claim 29, wherein the insulator layer is at most about 2000 angstroms in thickness.

39. The device of claim 29, further comprising a microfluidics or nanofluidics system for delivering the liquid analyte to the analyte chamber.

40. The device of claim 29, further comprising a detector located upstream of the analyte chamber in the microfluidics or nanofluidics system, which detector detects the presence of a biological component and communicates the presence of said biological component to allow analysis of the biological component at the coplanar waveguide.

41. The device of claim 40, wherein the detector is a capacitance cytometry device.

42. A device for characterizing a liquid analyte containing putative biological component, the device comprising:
a connector for connecting to a source of oscillatory electrical signals spanning a frequency range extending into at least the GHz range;
a coplanar waveguide comprising:
at least two outer conductors straddling
an inner conductor coupled to the connector in a manner allowing the inner conductor to carry the oscillatory signals extending into at least the GHz range, wherein the inner conductor has a gap; and
an ion impermeable insulator layer encapsulating at least a portion of the coplanar waveguide, including the gap in the inner conductor;
a fluidics system comprising a source of said liquid analyte and an analyte chamber located over at least the gap in the inner conductor, such that the liquid analyte can contact the insulator layer but not the inner conductor or outer conductors; and
a detector located upstream of the analyte chamber in the fluidics system, which detector detects the presence of a biological component and communicates the presence of said biological component to allow analysis of the biological component at the coplanar waveguide.

43. The device of claim 42, wherein the detector is a capacitance cytometry device.

44. The device of claim 42, further comprising the source of oscillatory electrical signals.

45. The device of claim 44, wherein the source of oscillatory electrical signals comprises a network analyzer.

46. The device of claim 44, wherein the source of oscillatory electrical signals comprises a network analyzer and an impedance analyzer.

47. The device of claim 44, wherein the source of oscillatory electrical signals comprises a plurality of oscillators for providing discrete oscillatory signals to the inner conductor, at least one of said oscillators providing an oscillatory electrical signal in the GHz range.

48. The device of claim 47, wherein the discrete oscillatory signals are at frequencies where the putative biological component provides characteristic electrical responses allowing discrimination of the biological component in the liquid analyte.

49. The device of claim 42, wherein the inner conductor has a width of between about 1 and 100 micrometers.

50. The device of claim 42, wherein the gap in the inner conductor has a length, in the direction of signal transmission, of between about 0.5 to 50 micrometers.

51. A method of detecting the presence of a biological component in a liquid analyte, the method comprising
passing the liquid analyte over a detector in a fluidics system, which detector detects the presence of a biological component and communicates the presence of said biological component to allow analysis of the biological component at a coplanar waveguide;
delivering the liquid analyte to an analyte chamber of the fluidics system;
transmitting oscillatory electrical signals spanning a frequency range extending into at least the GHz range to a coplanar waveguide comprising (a) at least two outer
